(19) United States
(12) Patent Application Publication
(10) Pub. No.: US 2017/0161757 A1
(43) Pub. Date: Jun. 8, 2017

(54) METHODS, SYSTEMS AND APPARATUS TO DETERMINE CHOICE PROBABILITY OF NEW PRODUCTS

(71) Applicant: The Nielsen Company (US), LLC, New York, NY (US)

(72) Inventors: Michael J. Zenor, Cedar Park, TX (US); Han Zeng, New York, NY (US); Mitchel Kriss, Long Grove, IL (US)

(21) Appl. No.: 15/299,854

(22) Filed: Oct. 21, 2016

Related U.S. Application Data
(60) Provisional application No. 62/264,440, filed on Dec. 8, 2015.

(51) Int. Cl. G06Q 30/02; G06N 5/02; G06N 7/00

(52) U.S. Cl. CPC G06Q 30/0202; G06N 7/005; G06N 5/022

(57) ABSTRACT

Methods, apparatus, systems and articles of manufacture are disclosed to determine choice probability of new products. An example disclosed apparatus to predict choice probability for a new product includes a log likelihood engine to calculate market level characteristic utilities associated with non-panelist aggregate sales data of market available products, the market available products having a same category type as the new product, a choice probability engine to calculate household level choice probabilities based on household utilities for respective ones of characteristics associated with the category type, the log likelihood engine to anchor the household level choice probabilities to the market level characteristic utilities with a penalty function, and a scoring engine to predict a choice probability for the new product in a household of interest based on the anchored household level choice probabilities.

### RELATED APPLICATION

This patent claims the benefit of U.S. Provisional Patent Application Ser. No. 62/264,440 filed on Dec. 8, 2015, which is hereby incorporated herein by reference in its entirety.

### FIELD OF THE DISCLOSURE

This disclosure relates generally to market analysis, and, more particularly, to methods, systems and apparatus to determine choice probability of new products.

### BACKGROUND

In recent years, consumers have been identified as having varying preferences for product characteristics, such as particular brand preferences, particular size preferences, particular flavor preferences, etc. Determining consumer-level characteristic preferences is typically accomplished via experimental survey data methods, in which survey participants are presented with experimentally controlled alternatives. During such surveys, the consumers are further asked to provide preference ratings for each of the products shown.

### BRIEF DESCRIPTION OF THE DRAWINGS

FIG. 1 is a schematic illustration of an example product analysis engine constructed in accordance with the teachings of this disclosure to determine choice probability of new products.

FIGS. 2-4 are flowcharts representative of example machine readable instructions that may be executed to implement the example product analysis engine of FIG. 1.

FIG. 5 is a block diagram of an example processor platform structured to execute the example machine readable instructions of FIGS. 2-4 to implement the example product analysis engine of FIG. 1.

### DETAILED DESCRIPTION

Experimental survey data techniques, such as conjoint analysis methods, permit the determination of consumer-level characteristic preferences, sometimes referred to herein as “utilities.” Generally speaking, conjoint analysis is an experimental technique that presents products to panelist-based survey participants and gathers feedback/input from those panelists indicative of preferences. Statistical analysis of the panelist input allows a determination of which particular attributes/characteristics of a product are more/less preferred than other attributes/characteristics. Each attribute and/or characteristic may be associated with numerical values based on a relative scale to other candidate attributes and/or characteristics.

While such conjoint analysis methods satisfy statistical expectations with regard to relatively localized environments, such methods are expensive to administer, occur under tightly controlled laboratory conditions and, thus, do not accurately reflect realistic consumer behavior in marketplace conditions. Additionally, the conjoint analysis methods utilize tightly controlled panelist data that would be cost prohibitive to administer to larger scales (e.g., at a regional level, a national level, etc.). Such challenges are further exasperated in view of the large characteristic variability that some products have. For example, product “1” may be associated with brand “A” in a strawberry flavor and a “large” size. The utility for product “1” is based on how much utility the consumer may have for each of the characteristics of brand, flavor and size. Yet other products exhibit combinations of other brands, other flavors and/or other sizes, thereby making the application of conjoint analysis techniques tedious, inefficient and expensive. In other words, determining consumer-level utilities on a large scale (e.g., regional level, national level) is limited by efficiency, cost and practicality.

Methods, apparatus, systems and articles of manufacture disclosed herein avoid such limitations and facilitate estimation of consumer-level characteristic utilities on large samples of panel data that (e.g., samples having thousands or millions of consumers). Rather than relying on panelist data to perform experimental methods (e.g., Conjoint Analysis), examples disclosed herein enable use behavioral data of any size, in which results improve with additional data points (e.g., purchase instances). Unlike expensive and tightly controlled panelist data having requisite samples to satisfy statistical significance, examples disclosed herein employ behavior data from any available source, including non-panelist data sources. In other words, data source restrictions are substantially relaxed with examples disclosed herein, and may include abundantly available retail measurement services (RMS) data, point of sale (POS) data, survey data and/or preferred shopper data. In some examples, RMS data, POS data and preferred shopper data are referred to as non-panelist data, which does not carry the substantial expense associated with panelist data. Additionally, data inputs may include heuristics from market analysts related to their assumptions of consumer behavior, in which such data may serve as a seed for iterative Bayesian analysis that yields improved accuracy as additional data points are provided (e.g., additional POS data). Accordingly, while statistical accuracy is traditionally poor and/or otherwise limited when using non-panelist data, examples disclosed herein improve statistical accuracy when calculating household level choice probability estimates in connection with non-panelist data.

Generally speaking, examples disclosed herein generate consumer-level estimates of utilities via a multi-stage Bayesian estimation that first estimates product characteristic utilities at a market-level with market-available products (e.g., using readily available RMS data, POS data, etc.), and then using purchase history data at a household/consumer level, re-estimates those same utilities at a consumer level (e.g., using analyst heuristics, preferred shopper data, panelist data, etc.), as described in further detail below. Additionally, in the event a market researcher wishes to estimate and/or otherwise score a new product (e.g., a product not yet sold and/or not otherwise provided/available in the market), examples disclosed herein calculate choice probabilities for such new product(s) for households of interest. As used herein, market-available products include those products that are available to consumers (e.g., via purchase), and have a known combination of characteristics (e.g., an existing and available combination of brand, flavor, size, etc.). Products exist within particular defined categories and/or sub-categories thereof. For example, product categories may include, but are not limited to food product categories, cleaning product categories, medicine categories, electronic device categories, home furnishing categories, etc. Additionally, sub-categories thereof may include, but are not limited to breakfast foods, frozen foods, canned foods, organic foods, gluten free foods, snack foods, floor cleaning products, toilet cleaning products, glass cleaning products, allergy relief products, pain relief products, antacid products, wireless telephone devices, gaming devices, etc. Without limitation, additional categories and/or, in some examples, sub-categories may include probiotic products, genetically modified organism (GMO) free products, grass fed products, licensed trademark products (e.g., products including trademarked cartoon characters), natural products, cruelty-free products, etc.

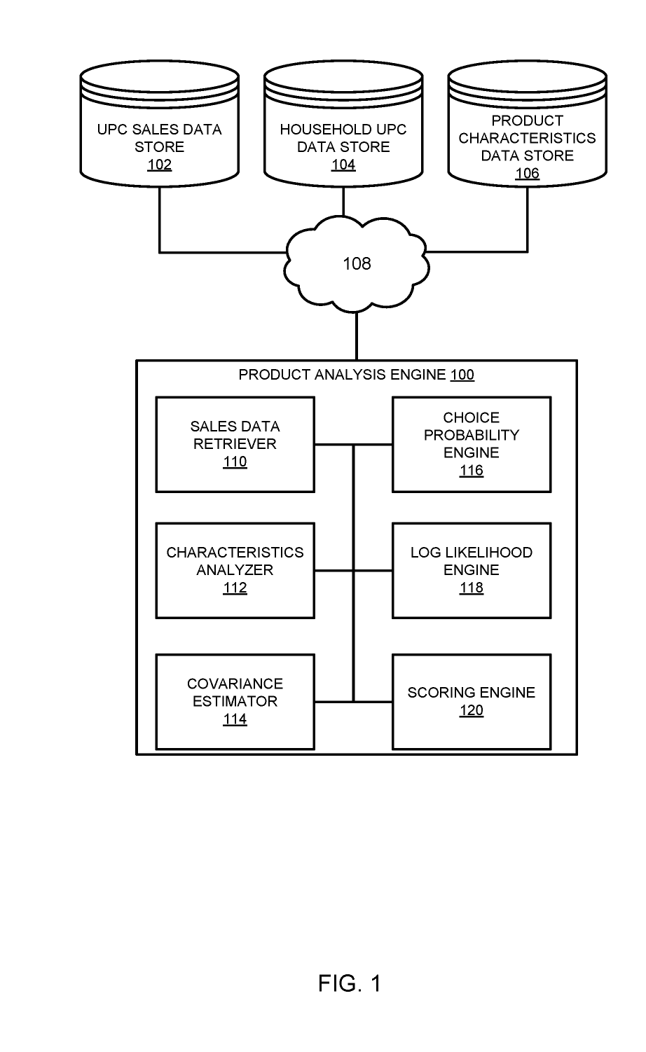

While conjoint analysis identifies consumer utilities for particular characteristics, example product analysis engines 100 disclosed herein take advantage of consumer purchase history data, which abstractly reflects relative utilities for each of the product characteristics. FIG. 1 illustrates an example implementation of such a product analysis engine 100. The product analysis engine 100 of the example of FIG. 1 is communicatively connected via one or more networks 108 to an example universal product code (UPC) sales data store 102, an example household UPC data store 104 and an example product characteristics data store 106.

In operation, the example UPC sales data store 102 includes and/or otherwise provides aggregate market sales data for market available products, such as quantities (e.g., in units, in dollars sold, etc.) of particular UPCs sold in particular market areas (e.g., particular geographic segments) during particular time periods (e.g., units sold in the last week, units sold in the last month, units sold in the last quarter, etc.). In some examples, the aggregate market sales data from the UPC sales data store is obtained from point-of-sale (POS) scanner data. In operation, the example household UPC data store 104 includes and/or otherwise provides market available household UPC sales data, which may be obtained from panelist data services (e.g., Nielsen Homescan), or may be data acquired through non-panelist techniques (e.g., preferred shopper data (e.g., shopper card data collected at the POS), analyst heuristics, analyst estimations, survey data, etc.). In some examples, the household UPC sales data includes particular market available UPCs purchased and/or otherwise acquired by household panelist members, for which demographic information may be available (e.g., household member age, race, income, gender, etc.). In operation, the example product characteristics data store 106 includes and/or otherwise provides characteristic and/or attribute information related to market available UPCs. In some examples, the product characteristics data store 106 is a database of market available product UPCs, each one having associated information related to its characteristics and attributes (e.g., size, brand, flavor, packaging units, organic/non-organic, color, etc.).

Generally speaking, traditional approaches to identify, determine and/or otherwise calculate individual level (consumer level, household level) data requires a requisite amount of panelist control and volume (e.g., number of data points) to provide results that are statistically significant. In other words, estimation of household level attributes normally requires a requisite amount of data points per household. Thus, in the event a single purchase in, for example, one category of interest occurs, this would not be enough information to estimate the importance of that attribute through a conjoint-style choice model. In some instances, marketing budgets and/or marketing computing resources preclude doing this for household sizes above one-thousand. As such, this explains why choice modeling is typically performed at an aggregate level or a segment level. Examples disclosed herein, thus, reduce and/or otherwise eliminate a need for large and robust data samples based on panelists. Additionally, examples disclosed herein acknowledge that in many instances panelist data that is relevant to the market study is not available, thus examples disclosed herein enable the use of a more generic and/or readily available data source(s) in an iterative manner (e.g., via example modified Bayesian analyses disclosed herein) to achieve relevant consumerization results.

In the illustrated example of FIG. 1, the product analysis engine 100 includes a sales data retriever 110, a characteristics analyzer 112, a covariance estimator 114, a choice probability engine 116, a log likelihood engine 118, and a scoring engine 120. In operation, the example product analysis engine 100 estimates market level characteristic utilities. In particular, the example product analysis engine 100 invokes the example sales data retriever 110 to identify a product type of interest that includes representative sales data found in the example UPC sales data store 102. Additionally, the example sales data retriever 110 obtains aggregate sales data for those market available products that are associated with the product type (category) and/or sub-type (sub-category) of interest. For instance, a product sub-type/sub-category of breakfast bar may have associated aggregate UPC sales data for any number of respective characteristics, such as different brands, different sizes, different flavors, etc. To identify the different combinations of possible characteristics from the UPC sales data, the example characteristics analyzer 112 queries the example product characteristics data store 106 to determine all available characteristics. Additionally, the example characteristics analyzer 112 generates a product characteristics matrix to identify intersecting characteristics of interest.

As an example, assume that the product sub-type of breakfast bar has three products, in which product “1” is associated with brand “A” and has a strawberry flavor, product “2” is associated with brand “A” and has a chocolate flavor, and product “3” is associated with brand “B” and has a strawberry flavor. In this example, there are two characteristics per product, one for brand and one for flavor. Additionally, each identified characteristic may have two possible values; (1) brand “A” or “B” and (2) flavor chocolate or flavor strawberry. The example characteristics analyzer 112 generates a coding matrix, as shown below in the illustrated example Table 1.

TABLE 1
$[ \begin{matrix}1 & 0 \\ 1 & 1 \\ 0 & 0\end{matrix} ] \begin{matrix}← Brand A ( strawberry ) \\ ← Brand A ( chocolate ) \\ ← Brand B ( strawberry )\end{matrix}$

In the illustrated example of Table 1, the first column represents whether brand “A” is true (1) or false (0) and the second column represents whether the chocolate flavor is true (1) or false (0). In this example, brand “B” is arbitrarily chosen as a reference or baseline level for the brand characteristic, while the strawberry flavor is chosen as a reference or baseline level for the flavor characteristic. Additionally, each of the rows represents one of the three (3) products. Generally speaking, a selection of the reference/baseline fixes those corresponding utilities (β) to zero (e.g., β_{brandA} and β_{brandB}=0), and the remaining utilities may be interpreted relative to their characteristic reference point.

For each product of interest, the example choice probability engine 116 determines a predicted choice probability based on aggregated product sales data in a manner consistent with example Equation 1.

$${P}_{u} = \frac{exp [ {\sum }_{C} {β}_{C} {X}_{uC} ]}{{\sum }_{u} exp [ {\sum }_{C} {β}_{C} {X}_{uC} ]} . \qquad Equation 1$$

In the illustrated example of Equation 1, Pᵤ reflects the predicted choice probability of product u, β_{C} reflects the utility of characteristic C, and X_{uC} reflects an indicator variable (0 or 1) denoting whether product u possesses characteristic C. Additionally, the example log likelihood engine 118 determines estimated market level utilities for each characteristic of interest (\hat{β}_{C}) by first applying a multinomial log likelihood function LL1 in a manner consistent with Equation 2, and then applying a maximization technique (e.g., Newton-Raphson). In some examples, the multinomial log likelihood function LL1 is referred to herein as a market-level log likelihood function.

$$LL 1 = {\sum }_{u} {n}_{u} ln ( {P}_{u} ) . \qquad Equation 2$$

In the illustrated example of Equation 2, nᵤ reflects the number of purchases of product u. As described above, while the Newton-Raphson technique may be applied to maximize the log likelihood function (LL1), associated covariance estimates, such as V(\hat{β}_{C}), may be derived from inversion of the Fisher Information Matrix evaluated at \hat{β}_{C}.

The above-identified estimates represent the characteristic utilities of the market in aggregate. However, the aggregate estimates may not necessarily reflect utilities of any particular consumer. For example, if the market contains an equal amount of consumers that like brand “A” and others that like brand “B,” total market estimates may indicate aggregate indifference between brands “A” and “B.” However, because the aggregate data is not limited to panelist data, but instead is collected across a large number of individuals (e.g., thousands or millions), it includes many more choices than any given individual panelist and, thus, it provides an opportunity to estimate utilities for a large number of characteristics.

Returning to the example above including three breakfast bar products, assume that the total number of purchases of those three products is a quantity of 4, 12 and 11. The example log likelihood engine 118, after maximizing the example log likelihood function (LL1) of example Equation 2 with respect to β_{brandA} and β_{chocolate}, yields estimates \hat{β}_{brandA}=−1.01 and \hat{β}_{chocolate}=1.10. These example results indicate that, at a market level, brand “B” is preferred to reference value brand “A,” and chocolate is preferred to its reference value strawberry. The example covariance estimator 114 calculates corresponding variances of these example estimates as V(\hat{β}_{brandA})=1.98 and V(\hat{β}_{chocolate})=2.32.

While the aforementioned examples yield estimated market level utilities of characteristics (\hat{β}_{C}), examples disclosed herein further derive characteristic utility estimates at a consumer level (e.g., household level). To accomplish this, the example product analysis engine 100 invokes the example choice probability engine 116 and the example household UPC data store 104 to calculate household level choice probabilities using utilities from household level data. In particular, the example choice probability engine 116 models choice probabilities for a product of interest u for a household of interest h with a second multinomial logit in a manner consistent with example Equation 3.

$${P}_{hu} = \frac{exp [ {\sum }_{C} {β}_{hC} {X}_{uC} ]}{{\sum }_{u} exp [ {\sum }_{C} {β}_{hC} {X}_{uC} ]} . \qquad Equation 3$$

In the illustrated example of Equation 3, Pₕᵤ represents the choice probability of product u for household h, and β_{hC} represents the utility of characteristic C for household h. An additional (second) log likelihood function (LL2) follows a multinomial form similar to example Equation 2, which is shown below as example Equation 4. In some examples, the second log likelihood function (LL2) is referred to herein as a household level log likelihood function.

$$LL 2 = {\sum }_{h} {\sum }_{u} {n}_{hu} ln ( {P}_{hu} ) . \qquad Equation 4$$

In the illustrated example Equation4, nₕᵤ represents a number of purchases of product u by household h.

To anchor household choice probability estimates with the previously calculated market level estimates, the example log likelihood engine 118 generates/calculates estimated utilities of characteristics for the household using a third log likelihood function (LL3), shown below as example Equation 5.

$$LL 3 = {\sum }_{C} - \frac{{( {\hat{β}}_{C} - {β}_{hC} )}^{2}}{2 V ( {\hat{β}}_{C} )} . \qquad Equation 5$$

The illustrated example of Equation 5 obeys Gaussian form and anchors the consumer level estimates through the market level estimates, and can be seen as a penalty for providing consumer level estimates that vary too far from the aggregate market level estimates. In some examples, the third log likelihood function (LL3) is referred to herein as a penalty log likelihood function. The example penalty log likelihood function of Equation 5 is based on, in part, the covariance estimates of the market level characteristics. Accordingly, the example log likelihood engine 118 maximizes the addition of LL2 and LL3 with respect to β_{hC} using Newton-Raphson or similar maximization techniques to estimate characteristic utilities for consumers associated with household h.

To illustrate, consider the previous examples above related to breakfast bars in which an individual consumer in household “1” that purchased a single bar of product “1” of brand “A” and the strawberry flavor. In isolation, this consumer's purchases would be too sparse to reliably model. However, by applying the aforementioned maximization, the corresponding Bayesian utility estimates are \hat{β}_{1,brandA}=0.48 and \hat{β}_{1,chocolate}=0.51. Accordingly, the maximization by the example log likelihood engine 118 facilitates estimation of characteristic utilities on a consumer with as few as one purchase. However, considering that it is likely that purchase instances will increase, estimation accuracy will likewise improve. In other words, the example estimation by maximization of the log likelihood functions LL2 and LL3 operate in a manner similar to a learning algorithm. While the above example included only a single purchase instance, the Bayesian estimates still predict that household “1” prefers brand “B” to brand “A” and the chocolate characteristic to the strawberry characteristic due to the fact that there is not enough evidence (in terms of other purchase instances) to overturn the market level estimates (priors).

To further illustrate with another example, consider household “2” that made three purchases of product “1” that represents brand “A” in the strawberry flavor (and no other purchases). The example choice shares of household “2” are the same as household “1”, but they are based on a larger sample of purchases. The corresponding Bayesian estimates for household “2” are then calculated by the example log likelihood engine 118 as \hat{β}_{2,brandA}=0.27 and \hat{β}2,_{chocolate}=−0.28. These example results indicate that household “2” prefers brand “A” to brand “B”, and the strawberry characteristic to the chocolate characteristic. As such, as consumers accumulate purchases in the category or product type of interest, examples disclosed herein update estimates of their relative product characteristic preferences.

Through repeated iterations of the Bayesian log likelihood maximization of LL2 and LL3 over the population of consumers, the example product analysis engine 100 derives a consumer-by-characteristic utility output dataset that includes each consumer's utility estimates for each characteristic value. In some examples, input datasets may include thousands of products, hundreds of characteristic values, and millions of consumers. Once completed, the output data generated by the example product analysis engine 100 may be used for demographic targeting purposes. For example, it may be learned that a particular utility for brand “A” is correlated with age and income. Additionally, examples disclosed herein may be further used to predict market potential for new and/or hypothetical items (e.g., products that are not yet available in the market and have not undergone panelist market study or focus group evaluations). To illustrate, in further view of the example breakfast bar products, assume there is no brand “B” having a chocolate flavor, yet the manufacturer of brand “B” may be interested in evaluating the potential market share of this hypothetical item. The example scoring engine 120 applies the consumer choice model in conjunction with the individual consumer product utility estimates as shown above in a manner consistent with example Equation 6.

$${\hat{P}}_{hu} = \frac{exp [ {\sum }_{C} {\hat{β}}_{hC} {X}_{uC} ]}{{\sum }_{u} exp [ {\sum }_{C} {\hat{β}}_{hC} {X}_{uC} ]} . \qquad Equation 6$$

In the illustrated example of Equation 6, \hat{P}ₕᵤ represents the predicted choice probability of new product u for household h. In view of example accumulated purchase data above, the example scoring engine 120 reveals that household “1” would have a 0.386 choice share probability for brand “B” in the chocolate flavor, and household “2” would have only a 0.187 choice share probability for that same product. Accordingly, such scoring may be repeated over all consumers/households of interest to produce an output of consumer level market potential for the example hypothetical product of interest.

While an example manner of implementing the product analysis engine 100 of FIG. 1 is illustrated in FIG. 1, one or more of the elements, processes and/or devices illustrated in FIG. 1 may be combined, divided, re-arranged, omitted, eliminated and/or implemented in any other way. Further, the example UPC sales data store 102, the example household UPC data store 104, the example product characteristic data store 106, the example sales data retriever 110, the example characteristics analyzer 112, the example covariance estimator 114, the example choice probability engine 116, the example log likelihood engine 118, the example scoring engine 120 and/or, more generally, the example product analysis engine 100 of FIG. 1 may be implemented by hardware, software, firmware and/or any combination of hardware, software and/or firmware. Thus, for example, any of the example UPC sales data store 102, the example household UPC data store 104, the example product characteristic data store 106, the example sales data retriever 110, the example characteristics analyzer 112, the example covariance estimator 114, the example choice probability engine 116, the example log likelihood engine 118, the example scoring engine 120 and/or, more generally, the example product analysis engine 100 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example UPC sales data store 102, the example household UPC data store 104, the example product characteristic data store 106, the example sales data retriever 110, the example characteristics analyzer 112, the example covariance estimator 114, the example choice probability engine 116, the example log likelihood engine 118, the example scoring engine 120 and/or, more generally, the example product analysis engine 100 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example product analysis engine 100 of FIG. 1 may include one or more elements, processes and/or devices in addition to, or instead of, those illustrated in FIG. 1, and/or may include more than one of any or all of the illustrated elements, processes and devices.

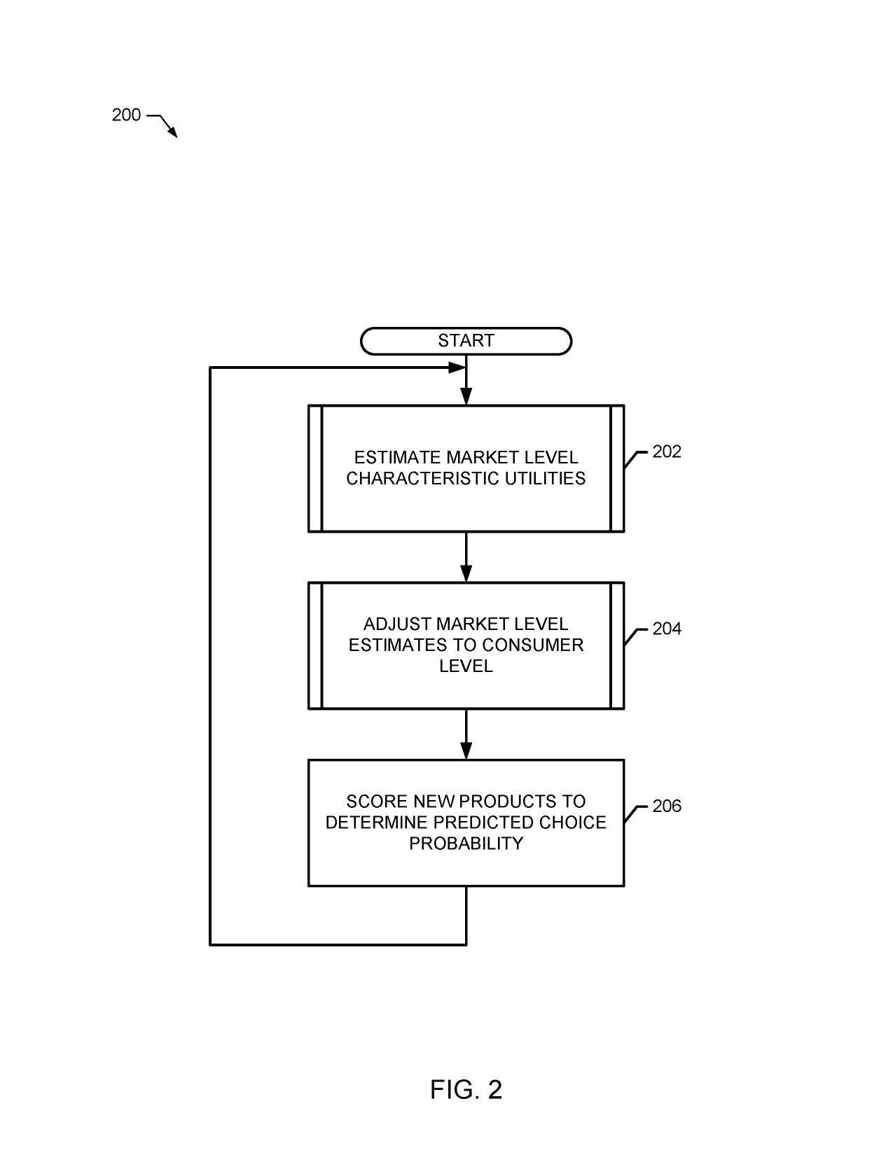

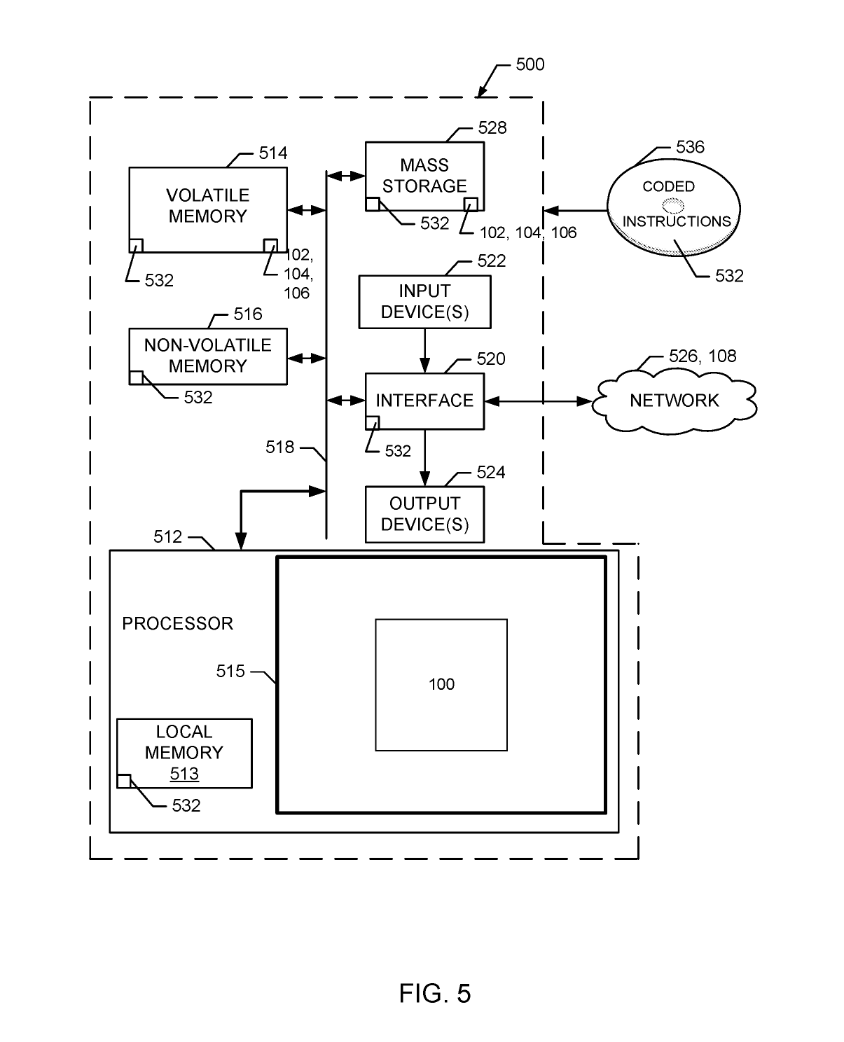

Flowcharts representative of example machine readable instructions for implementing the product analysis engine 100 of FIG. 1 are shown in FIGS. 2-4. In these examples, the machine readable instructions comprise a program(s) for execution by a processor such as the processor 512 shown in the example processor platform 500 discussed below in connection with FIG. 5. The program(s) may be embodied in software stored on a tangible computer readable storage medium such as a CD-ROM, a floppy disk, a hard drive, a digital versatile disk (DVD), a Blu-ray disk, or a memory associated with the processor 512, but the entire program(s) and/or parts thereof could alternatively be executed by a device other than the processor 512 and/or embodied in firmware or dedicated hardware. Further, although the example program(s) is/are described with reference to the flowcharts illustrated in FIGS. 2-4, many other methods of implementing the example product analysis engine 100 may alternatively be used. For example, the order of execution of the blocks may be changed, and/or some of the blocks described may be changed, eliminated, or combined.

As mentioned above, the example processes of FIGS. 2-4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 2-4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program 200 of FIG. 2 begins at block 202 where the example product analysis engine 100 estimates market level characteristic utilities, as described in further detail below. The example product analysis engine 100 further adjusts the market level estimates to a consumer level (block 204), and the resulting consumer level data is used by the example scoring engine 120 to score new products to determine predicted choice probability (block 206).

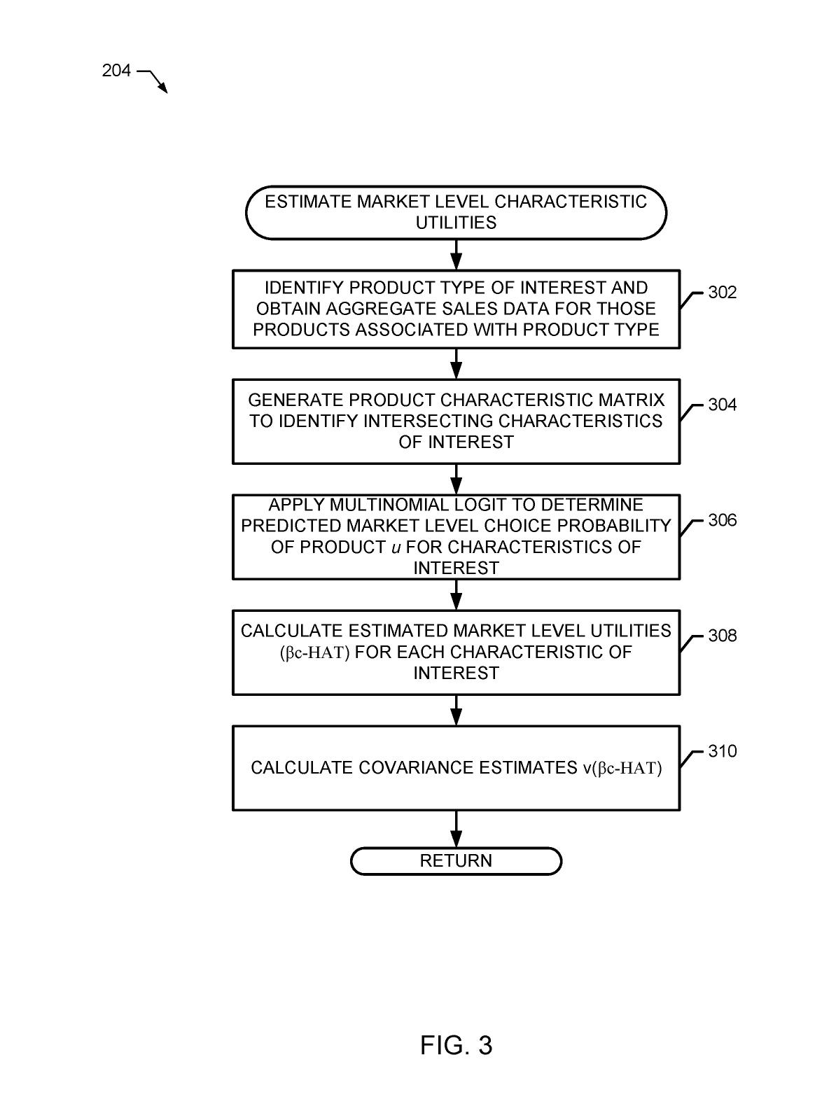

FIG. 3 illustrates an example manner of implementing block 202 of FIG. 2 to estimate market level characteristic utilities. In the illustrated example of FIG. 3, the example sales data retriever 110 identifies a product type of interest (e.g., breakfast bars, as described in examples above) that have associated sales data available in the example UPC sales data store 102 (block 302). Further, the example sales data retriever 110 obtains aggregate sales data for those products that are associated with the product type of interest (block 302). Because candidate products may have any number of characteristics, the example characteristics analyzer 112 queries the example product characteristics data store 106 to determine all available characteristics for those products that have associated aggregate sales data (block 304). Additionally, the example characteristics analyzer 112 generates a product characteristics matrix to identify intersecting characteristics of interest, an example of which is discussed above in connection with Table 1 (block 304).

The example choice probability engine 116 determines a predicted choice probability for each product of interest, in which the predicted choice probability is based on the aggregated product sales data (block 306). As described above, the example choice probability engine 116 calculates the predicted choice probability in a manner consistent with example Equation 1. The example log likelihood engine 118 determines estimated market level utilities for each characteristic of interest (\hat{β}_{C}) by first applying a multinomial log likelihood function LL1 in a manner consistent with Equation 2, and then applying a maximization technique (e.g., Newton-Raphson) (block 308). Additionally, the example covariance estimator 114 applies an inversion of the Fisher Information Matric evaluated \hat{β}_{C} at to calculate associated covariance estimates V(\hat{β}_{C}) (block 310). Control then advances to block 204 of FIG. 2.

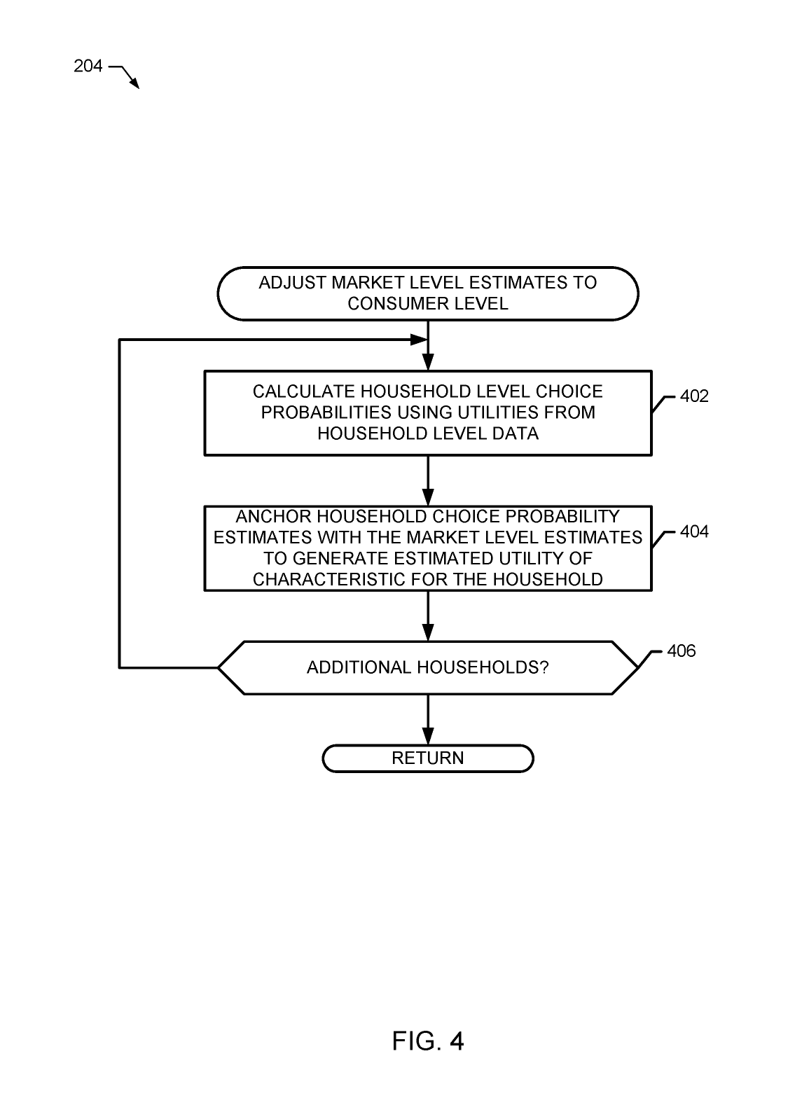

As discussed above, the example product analysis engine 100 adjusts market level estimates, as shown above, to a consumer level (block 204). FIG. 4 illustrates an example manner of implementing block 204 of FIG. 2 to adjust market level estimates to consumer levels. In the illustrated example of FIG. 4, the example choice probability engine 116 calculates (e.g., models) household level choice probabilities using utilities from household level data acquired from the example household UPC data store 104 (block 402). As discussed above, the choice probability engine 116 models the choice probabilities in a manner consistent with example Equation 3. Additionally, the example log likelihood engine 118 anchors the calculated choice probability estimates with the market level estimates to calculate an estimated utility of characteristics for the household of interest (block 404). In particular, the example log likelihood engine 118 applies a second log likelihood function (LL2) in a manner consistent with example Equation 4 and anchors those household choice probability estimates with a penalty log likelihood function (LL3) in a manner consistent with example Equation 5 (block 404). The addition of LL2 and LL3 is maximized with respect to the utility of characteristic C for household h using a maximization technique, such as Newton-Raphson (block 404). In the event there are additional households for which characteristic utility estimates are to be calculated (block 406), then control returns to block 402 in view of data from that additional household.

Returning to the illustrated example of FIG. 2, a new product having candidate characteristic combinations is scored by the example scoring engine 120 (block 206). In particular, the example scoring engine 120 applies such new/alternate characteristic data and applies the consumer choice model in a manner consistent with example Equation 6, which yields a predicted choice probability of a new product u for household h (block 206).

FIG. 5 is a block diagram of an example processor platform 500 capable of executing the instructions of FIGS. 2-4 to implement the product analysis engine 100 of FIG. 1. The processor platform 500 can be, for example, a server, a personal computer, an Internet appliance, or any other type of computing device.

The processor platform 500 of the illustrated example includes a processor 512. The processor 512 of the illustrated example is hardware. For example, the processor 512 can be implemented by one or more integrated circuits, logic circuits, microprocessors or controllers from any desired family or manufacturer. In the illustrated example of FIG. 5, the processor 500 includes one or more example processing cores 515 configured via example instructions 532, which include the example instructions of FIGS. 2-4 to implement the example product analysis engine 100 of FIG. 1.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and commands into the processor 512. The input device(s) can be implemented by, for example, an audio sensor, a microphone, a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives. In some examples, the mass storage device 528 may implement the example UPC sales data store 102, the example household UPC data store 104 and/or the example product characteristic data store 106.

The coded instructions 532 of FIGS. 2-4 may be stored in the mass storage device 528, in the volatile memory 514, in the non-volatile memory 516, and/or on a removable tangible computer readable storage medium such as a CD or DVD.

From the foregoing, it will be appreciated that methods, apparatus and articles of manufacture have been disclosed that improve statistical accuracy when calculating household level choice probability estimates using non-panelist data. Additionally, examples disclosed herein reduce processing burdens typically required when choice modeling activities are performed, and eliminate computational burdens otherwise required from a strict reliance on panelist data.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus to predict choice probability for a new product, comprising:
a log likelihood engine to calculate market level characteristic utilities associated with non-panelist aggregate sales data of market available products, the market available products having a same category type as the new product;
a choice probability engine to calculate household level choice probabilities based on household utilities for respective ones of characteristics associated with the category type, the log likelihood engine to anchor the household level choice probabilities to the market level characteristic utilities with a penalty function; and
a scoring engine to predict a choice probability for the new product in a household of interest based on the anchored household level choice probabilities.

2. The apparatus as defined in claim 1, wherein the choice probability engine is to model a first multinomial logit to determine a predicted choice probability for a respective market available product, and the log likelihood engine is to maximize the predicted choice probability by executing a market level log likelihood function.

3. The apparatus as defined in claim 2, wherein the log likelihood engine is to apply a Newton-Raphson technique to the market level log likelihood function.

4. The apparatus as defined in claim 1, wherein the category type includes at least one of a food product category, a cleaning product category, a medicine category, an electronic device category, or a home furnishing category.

5. The apparatus as defined in claim 4, wherein the category type includes a sub-category.

6. The apparatus as defined in claim 5, wherein the food product category includes a sub-category of at least one of breakfast foods, frozen foods, canned foods, organic foods, gluten free foods, or snack foods.

7. The apparatus as defined in claim 1, further including a sales data retriever to acquire non-panelist universal product code (UPC) data associated with the household of interest, wherein the choice probability engine is to model a second multinomial logit with the household utilities for respective ones of characteristics associated with the category type to calculate a choice probability of market available products purchased by the household of interest.

8. (canceled)

9. (canceled)

10. (canceled)

11. A computer implemented method to predict choice probability for a new product, comprising:
calculating, by executing an instruction with a processor, market level characteristic utilities associated with non-panelist aggregate sales data of market available products, the market available products having a same category type as the new product;
calculating, by executing an instruction with the processor, household level choice probabilities based on household utilities for respective ones of characteristics associated with the category type;
anchoring the household level choice probabilities to the market level characteristic utilities with a penalty function by executing an instruction with the processor; and
predicting, by executing an instruction with the processor, a choice probability for the new product in a household of interest based on the anchored household level choice probabilities.

12. The computer implemented method as defined in claim 11, wherein the calculating of the market level characteristic utilities includes modeling a first multinomial logit to determine a predicted choice probability for a respective market available product, and maximizing the predicted choice probability by executing a market level log likelihood function with the processor.

13. The computer implemented method as defined in claim 12, further including applying a Newton-Raphson technique to the market level log likelihood function.

14. (canceled)

15. (canceled)

16. (canceled)

17. The computer implemented method as defined in claim 11, further including:
acquiring non-panelist universal product code (UPC) data associated with the household of interest; and
modeling a second multinomial logit with the household utilities for respective ones of characteristics associated with the category type to calculate a choice probability of market available products purchased by the household of interest.

18. The computer implemented method as defined in claim 17, further including maximizing the choice probability by executing a household level log likelihood function with the processor, the household level log likelihood function based on a number of purchases of the product of interest by the household of interest.

19. The computer implemented method as defined in claim 11, further including calculating covariance estimates of the market level characteristic utilities by inverting a Fisher Information Matrix evaluated based on the market level characteristic utilities.

20. The computer implemented method as defined in claim 19, wherein the penalty function is a log likelihood function based on the covariance estimates of the market level characteristics.

21. A tangible machine-readable storage medium comprising instructions that, when executed, cause a process to at least:
calculate market level characteristic utilities associated with non-panelist aggregate sales data of market available products, the market available products having a same category type as the new product;
calculate household level choice probabilities based on household utilities for respective ones of characteristics associated with the category type;
anchor the household level choice probabilities to the market level characteristic utilities with a penalty function; and
predict a choice probability for the new product in a household of interest based on the anchored household level choice probabilities.

22. The machine-readable storage medium as defined in claim 21, wherein the instructions, when executed, further cause the processor to:
model a first multinomial logit to determine a predicted choice probability for a respective market available product; and
maximize the predicted choice probability by executing a market level log likelihood function.

23. The machine-readable storage medium as defined in claim 22, wherein the instructions, when executed, further cause the processor to apply a Newton-Raphson technique to the market level log likelihood function.

24. The machine-readable storage medium as defined in claim 22, wherein the instructions, when executed, further cause the processor to identify a category type of at least one of a food product category, a cleaning product category, a medicine category, an electronic device category, or a home furnishing category.

25. The machine-readable storage medium as defined in claim 24, wherein the instructions, when executed, further cause the processor to identify a sub-category of the category type.

26. The machine-readable storage medium as defined in claim 25, wherein the instructions, when executed, further cause the processor to identify a sub-category of the food product category of at least one of breakfast foods, frozen foods, canned foods, organic foods, gluten free foods, or snack foods.

27. (canceled)

28. (canceled)

29. (canceled)

30. (canceled)
